(19) United States
(12) Patent Application Publication
(10) Pub. No.: US 2011/0321017 A1
(43) Pub. Date: Dec. 29, 2011

(54) COMPUTER CODE DEBUGGING METHOD AND APPARATUS PROVIDING EXCEPTION BREAKPOINTS

(75) Inventors: Sandhya Kapoor, Austin, TX (US); Lohith Ravi, Bangalore (IN)

(73) Assignee: International Business Machines Corporation, Armonk, NY (US)

(21) Appl. No.: 12/826,352

(22) Filed: Jun. 29, 2010

(51) Int. Cl. G06F 11/36

(52) U.S. Cl. 717/129

(57) ABSTRACT

A computer method and apparatus for debugging program code provides exception breakpoints with exception notification. Through a user interface, a user associates one or more exception breakpoints with respective different certain lines of code. A computer processor is configured to execute the subject program code in debug mode. During the executing, for each of the different certain lines of code, the processor: (a) pauses to pre-evaluate and determine tendency to throw an exception or spawn an interrupt, and (b) at the certain line of code, stops execution of the subject program code only if the pre-evaluating determined existence of a would-be exception or run-time interrupt.

### BACKGROUND

When developing a software program, debugging of the program code is a very important aspect in creating an “Error Free” or “Bug free” software. In order to ensure the quality of the software product, millions of dollars are spent on debugging. The procedure of solving the Defect/CR/PMR is often difficult and time consuming, even though the programmed debugging exceptions are thrown and can be viewed along the stack trace. Consuming time is an important aspect to be considered.

Debugging is often performed in the following manner:

find a program part (portion of code) which causes problems that may have caused the exception,

find relevant lines of the program code,

set breakpoints in a few approximate places in the relevant lines of program code which are of interest with regard to the status of certain variables, and

execute the program code with a debugging software (“debugger”). In the process of executing the debugger, a run-time environment of the program developing environment starts executing the program code. The debugger process stops program execution at the first breakpoint in the order of the execution, and the developer either proceeds step-by-step or step-over plus step-by-step analyzing the content of the variables. Developer analysis may also shift from one breakpoint to another.

The problems with the current procedure are many. For one, in order to run through the current debug points, a failure due to the program code (bug) may exist or may not. However the mechanism of choosing the breakpoints is the same.

Second, there are situations where one knows that the subject code is throwing exceptions, but one has to see the execution log and analyze or suspect the part of code which may be throwing the exception. Also one has to apply a breakpoint at a location (line) in the code to stop at that point.

Next, after one puts some fix in the same place, whether the problem exists there or not, the debug breakpoint stops there. Then the developer has to remove the debug breakpoint after he feels that the debug breakpoint is not necessary.

Lastly, if there is a code snippet which throws a runtime exception, finding which statement (line of code, operation/variables in that line, etc) is throwing the exception consumes time and resources. Requiring the programmer to go to a step by step analysis waiting for exceptions to be thrown is unacceptably tedious and time and resource consuming.

### BRIEF SUMMARY

The present invention addresses the foregoing problems and shortcomings of the prior art. The present invention is focused on assigning or associating exception notification to the breakpoints of the code running under debug-mode. The invention relates to methods, computer program products and systems for debugging a program code. The debugging breakpoints are assigned solely based on respective line-specific failures in the program code. Restated, the present invention provides a new kind or version of breakpoint that is effectively an exception breakpoint (or exception notification breakpoint) which only stops debugger execution of program code when pre-evaluation of the associated line of code encounters a would-be exception or a would-be run-time (error-based) interrupt. The invention exception breakpoint (exception notification breakpoint) causes that single line to be pre-evaluated rather than just handling the error/exception like another try/catch block as in the prior art.

Embodiments associate exception breakpoints of the present invention with respective certain lines (i.e., specific line locations) in the subject program code. Thus debugger execution of the subject application program or subject code breaks/stops at an exception breakpoint only when debugger pre-evaluation of the statement associated with the exception breakpoint encounters or otherwise determines existence of a would-be exception (or would-be runtime interrupt). Further, embodiments associate exception notification with exception breakpoints of the present invention. When debugger execution of the subject program code arrives at an exception breakpoint that has associated exception notification, the debugger pauses and pre-evaluates the debug-statement (i.e., the code statement that is associated with the exception breakpoint) and stops at that point if an exception would be thrown (or interrupt spawned) by that line of code. In turn, the developer or the user can analyze the variables and add watch expressions. All the features supported by a debugger are made available for the invention exception breakpoints.

A user in prior art typically proceeds in the debugging process step by step through subject lines of code. Sometimes he cannot determine whether he needs to really move to the next step versus take a step-over. In such scenarios the user greatly benefits from embodiments of the present invention where the system pre-evaluates and notifies the user if there is a potential exception/error interrupt. In turn, this enables the user to determine how to proceed, i.e., step-up or step-over, and the like.

In one embodiment, the invention exception breakpoint is implemented using a breakpoint option referred to as the Failure Breakpoint Enable option or the Exception Breakpoint option, for example. When a developer uses this Failure Breakpoint Enable option, program control stops/breaks at that point (line location in the code where the exception breakpoint has been applied) only when the statement there is determined by the pre-evaluator to have a tendency to throw an exception/spawn an interrupt.

Embodiments of the invention are more user-friendly to operate, to debug with and arrive at decisions than in prior art systems/methods of debugging. For example, managing exceptions for a group of classes or for a set of lines in the prior art can later collide with multiple such sets and filtering. Such group exceptions require careful handling by the user and are often so difficult and confusing that only advanced users can handle with the options available in the prior art. In contrast, the present invention approach/design is easy and user-friendly for the user (developer). The approach/focus is not on sets of classes/code lines, but instead is on association of a notification trigger with a breakpoint (existing or new).

Embodiments of the present invention include a computer method, system and apparatus comprising:

a source of exception notification breakpoints, given a subject program code, one or more of the exception notification breakpoints being associated with respective different certain lines of code; and

a processor executing the subject program code in debug mode, and during said executing, for each of the different certain lines of code, the processor: (a) determining tendency to throw an exception, and (b) at the certain line of code, stopping execution of the subject program code only if the certain line of code is determined to tend to result in an exception (presents a potential exception). In one embodiment, the determining includes pausing and pre-evaluating the certain line of code.

In accordance with one aspect of the present invention, the step of associating includes defining the one or more exception notification breakpoints by enabling a respective property option in each exception breakpoint. In embodiments, the property option is user-enabled. In other embodiments, the exception breakpoint/exception notification breakpoint is defined by a command line option.

In embodiments, the step of determining determines tendency of the certain line of code to spawn an error-based interrupt. The step of stopping stops execution of the subject program only if the certain line of code is determined as tending to spawn an error-based interrupt (has a potential interrupt).

In accordance with another aspect of the present invention, each exception breakpoint is specific to a respective line location in the code, so as to be code line location specific. In embodiments, the step of associating effectively assigns exception notification to code-line location specific breakpoints.

In embodiments, the determining and stopping simplifies error/failure analysis. The error/failure analysis includes analysis of failures due to null pointer, array out of bounds, file not found and the like.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of one embodiment of the present invention.

FIG. 2 is a flow diagram of one embodiment.

FIG. 3 is a block diagram of a computer in the network of FIG. 4 deploying the present invention.

FIG. 4 is a schematic view of a computer network environment in which embodiments of the present invention are deployed.

FIG. 5 is a schematic view of another embodiment of the present invention.

### DETAILED DESCRIPTION

To provide context and greater understanding of the present invention, a brief example of the prior art is presented next and followed by a description of embodiments of the present invention.

### PRIOR ART EXAMPLE

| | |
|---|---|
| public void main(String str[ ]) | |
| { | |
| int a, b; | |
| a = f(b); | |
| a+ = a; | |
| b* = a; | |
| } | |
| public int f(int b) | **throws Exception ** |
| { | |
| int t = math factorial(b); | **Exception occurs at this point** |
| return t+b; | |
| } | |

In processing the above snippet by prior art debuggers (such as that in U.S. Pat. No. 6,493,834), the four lines of code from “int a, b;” through “b*=a” form an “Exception Handling Region.” If execution (in debug mode) throws an exception, then the debugger checks that whole region. For instance, when execution (in debug mode) comes to code line a=f(b), the entire function f(b) gets executed. That is, control passes to “public int f(int b)” and during execution of this function, the execution of statement “int t=math factorial(b)” throws an exception, for example. In turn, debugging execution stops at code line “a=f(b)” after executing the function “public int f(int b)”. Thus debugger execution breaks as triggered by the exception handling.

In the above, the prior art system provides exception handling where if an exception occurs in the region, then a breakpoint pauses execution. It is noted that there are side-effects created (from execution of the exception), and none of the advantages of pre-evaluating the expression separately are present (as will be seen below in the present invention). The problem here in the prior art is that the exception has already occurred, so one cannot roll back the exception or the effects of the exception. That is to say, the breakpoint stops after execution throws an exception, so the exception is already thrown and the operations associated with that are already done (i.e., exception handling is done like any other try catch in the prior-art or the catch block actually has its breakpoint interrupt stop the execution.).

Further if there are multiple exceptions occurring across the given Exception Handling Region, then the breakpoints cause stopping at locations which the user does not prefer and which the user does not want to debug at this instance. Such results in extra effort in searching for the appropriate exception. This is an inefficient use of resources. Also where an exception is handled by (triggers) the breakpoint, re-handling a related expression in a line of code appearing later in the subject program can not be done at all. Restated, in the prior art the focus is on exception handling for a code-snippet whereas in contrast the present invention is about relating/associating an exception notification option to a debug-point.

Lastly why should the debugger handle all the exceptions in the Exception Handling Region. Debug operations are very costly compared to execution operations, and thus the debugger handling all the exceptions is not economical and has performance drawbacks. In the present invention, applicants are not allowing the debugger to do certain exception handling in contrast to the currently available systems in the art. As will become clearer below, embodiments of the invention pre-evaluate code lines with the help of a new instance of Executor (JVM) by passing the required variables and their values and the subject code segment.

The prior art also fails in the following example. Say there is a code snippet and exception handling is already done in a set of code like:

```
Try {
    Array[100]=20; //If this region is under exception handling of
    prior art
    ...
    ...
}
Catch(Exceptn.ex)
{
    Array[Last]=20
}
```

In the above code, using the prior art theory, a region of code lines is assigned to handle breakpoint exceptions. If an ArrayIndexOutOfBoundException occurs then the exception is handled by the debugger at Array[100]=20 and thus re-handling in Array[Last]=20 cannot be done. Most of the situations of exception handling are around this. Whereas the present invention solution pre-evaluates code statements at a breakpoint that the user suspects to have an exception, thus helping the user to re-handle the same exception in later code lines.

In the above case, a prior art debugging process cannot determine whether to provide exception handling in the Catch procedure (portion of code) or to break. So the exception handling is done by the debugger to break at that point. The prior art debugging systems do not ask the user whether to handle exceptions in the Catch portion of code or to break. This is a non-user friendly aspect of the prior art.

In contrast, as will be made clear below, the present invention associates an exception (or exception option) with a breakpoint (pre-existing or during new creation) as opposed to the exception handling triggering a breakpoint. The association is to a particular breakpoint (solely) individually. In the prior art, exception handling is done on a set of code lines/piece of code or set of Classes, and the result is based on the exception thrown within this set. Whereas in the present invention:

(a) the breakpoints (herein “exception breakpoints” or “exception notification breakpoints”) are program code line specific (i.e., specific to a respective certain line or statement location in the subject program code);

(b) each exception breakpoint is enabled with exception notification; and

(c) each exception breakpoint causes the debugger to pre-evaluate (not fully execute) the associated code line and to stop processing only if there is an exception encountered (i.e., only if it determines existence of a would-be exception or a tendency to throw an exception). The present invention approach looks for exceptions/would-be exceptions in a line location of the code only if the breakpoint associated with the line of code is an exception breakpoint (or exception notification breakpoint).

In one embodiment, exception notification is enabled through command line debuggers like JDB/GDB.

The present invention distributes the work between IDE (integrated development environment) and JVM (Java virtual machine) relieving the debugger from handling the majority of the work. Embodiments of the present invention notify the user of potential exceptions (interrupts) and enable the user to determine a best course of action (step-over, step-in, break and the like) on a per code line basis. That is, since the present invention is about associating and enabling notification of a would-be exception/would-be interrupt (fault) through a breakpoint, there are performance benefits for debuggers. Pre-evaluating a line of code does not mean that the code line should be a plain-statement or expression, but the code line can also be a function/code segment which in turn calls many functions. This is another contrast to the existing art systems.

The present invention does not interfere in exception-handling that is done like in try/catch by the Executor (JVM), rather it makes a separate evaluation, i.e., handling as a separate bunch of code to check for error faults or exceptions. This assists the user in making various decisions in his debugging, saving him time and relieving him of some complexity in contrast to prior art debugging approaches and systems.

Applicants' Solution

The following is intended to be a non-limiting illustrative description of the principles and aspects of the present invention. Although the example discussed below and the snap-shot is with respect to Java and Eclipse, any debugger, independent of language, can use the invention Failure Breakpoint Enable option. The command line option shown and described below is also an important option. Even if there is no exception handling supported by some languages and debuggers, the runtime faults may be an alternative for exceptions in those cases and the runtime faults may be captured by corresponding interrupts using embodiments of the present invention.

Thus the present invention has advantages in debugging sizeable computer/application programs especially in large development environments. Embodiments include software development products.

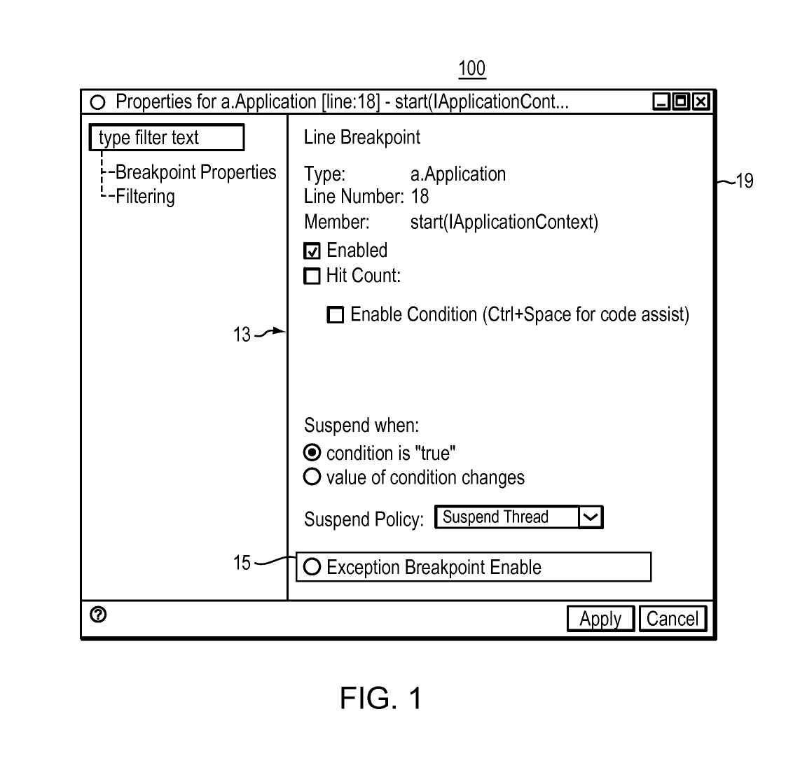

With reference now to FIG. 1, a debugging system (or computer system generally) 100 embodying the present invention is presented. An application program is running on a code base under debug mode. The user chooses some selective lines (statements) in the program code and applies exception breakpoints 19 of the present invention which includes enabling the “Exception Breakpoint Enable” option 15. He enables this option 15 if he expects exceptions will be thrown when failures occur at the selected line locations in the code. Thus the user applies respective exception breakpoints 19 of the present invention at the selected lines (code statements) and associates exception breakpoints 19 with respective specific line locations in the code.

For each exception breakpoint 19, invention system 100 defines respective breakpoint properties. Toward that end, system 100 provides in a user interface (e.g., dialog box) 13 indications of attributes and property settings for the exception breakpoint 19. In particular, system 100 provides to the user (in the user interface 13) the invention option 15, shown in some embodiments as the Exception Breakpoint Enable option. Common techniques are utilized for implementing and supporting source, configuration and operation of exception breakpoints having user-settable option 15.

The user selecting or otherwise enabling this option 15 causes the processor/system 100 to pause and pre-evaluate (i.e., before executing) the subject code statement associated with this exception breakpoint 19. Only if the statement pre-evaluation throws or tends to throw an exception (and thus determines a would-be or potential exception), does the associated exception breakpoint 19 stop program execution. As a result, exception breakpoint 19 serves as an exception notification to the user (and hence an exception notification breakpoint 19). Otherwise, the exception breakpoint 19 does not stop program execution at that position (line and statement) in the code.

In this way, the system 100 enables the user (e.g., Developer) to analyze the variables, add watch expressions etc. All the features supported by the debugger when the execution pauses at the exception breakpoint 19 are made available even for those that result in a code/operation failure using known or common debugger technology and techniques. In some embodiments, system 100 processes or otherwise responds to exception breakpoints 19 by generating a new instance of the Executer (JVM). In that case, on initiation of the new instance, system 100 passes in the required variables, their values and the associated line of code corresponding to the exception breakpoint 19.

The following is an example from a Developer's perspective.

```
    Sample Subject Program Code
public class important {
    public static void main (String str[ ])
    {
      int a = 0;
      int b = 20;
      String s = “cool”;
      int c;
      c = Func(b,a); **Exception Breakpoint 19 associated here**
      System.out.println (c);
      }
      public int Func(int b, int a)
      {
        int t = b/(a+b);
        return 1 − t;
      }
}
```

The Developer runs the above code in debug mode after defining and applying an exception breakpoint 19 of the present invention at the statement “c=Func(b,a)”. This includes having enabled the invention option 15 in the breakpoint properties or definition of the exception breakpoint 19. Because the Developer applied an exception breakpoint 19 of the present invention (and not a typical breakpoint of prior art), debugger execution pauses and pre-evaluates the associated line of code (i.e., c=Func(b,a)), and stops execution at that location in the code (i.e., at statement c=Func(b,a)) only if the “c=Func(b,a)” expression or statement shows a tendency to throw an exception or otherwise shows existence of a potential (would-be) exception. The entire function Func(b,a) is pre-evaluated for tendency to throw an exception, but unlike prior art the function is not executed. Further, other typical or traditional breakpoints (e.g., without enabling the invention option 15) would cause execution to stop whether or not the subject line of code (expression or statement) throws an exception. Exception breakpoint 19 having option 15 enabled thus serves as an exception notification to the user for the subject code line (i.e., c=Func(b,a)).

Whatsmore, the invention exception breakpoint 19 at “c=Func(b,a)” causing a pause (to pre-evaluate that line of code) during debugging is timely and most helpful to the user. During the debugging process up to this point, the user may not know whether to step-into or step-over the given function Func(b,a). Utilizing the invention exception breakpoint 19 and its pause at the corresponding code line, the user is able to observe and evaluate the various variable values and other effects of the prior lines of code. In turn, the user is better equipped to determine the best next step in proceeding with the debugging process.

Either by analyzing the execution type due to interruption or by analyzing variables, the Developer/user has a clear opportunity to change the code instantaneously. For example, he could change the subject statement to int c=b/a. And then he continues program execution (in debug mode) without having to restart the application.

This type of continuation of program execution in debug mode can be supported by virtual machines like JVM (Java Virtual Machine) through mechanisms like Hot-code replacement. This helps a lot when a user is running a heavy application like server or runtime code which may take several minutes to arrive at the subject point (line location in the code) on restarting the application in debug-mode. The continuation avoids debug execution of the program from having to go through various other debug-breakpoints to arrive at the subject location in the code.

It is not only helpful in the case of continuation processing, but the present invention also helps in analyzing errors, especially when searching deep for the cause of a failure. In this case, the present invention provides the advantage of not having to put traditional breakpoints in promising functions where execution stops at that point whether or not the code statement throws an exception/exception notification breakpoint 19.

Embodiments of the present invention simplify error/failure analysis (such as of failures like NullPointer, ArrayOutOfBounds, FileNotFound, . . . etc.) and as a result help to debug code in fields of cache memory level 3 with ease. One particular advantage is the ability to run the subject program on the Developer's environment in debug-mode having the invention breakpoint option 15 enabled in all breakpoints. For each execution breakpoint 19, execution stops only at the associated certain code line/respective code line location and only if there is a pre-evaluated failure (meaning that that code line is pre-evaluated to produce a would-be exception or interrupt). If there is no failure/would-be exception thrown that was occurring previously, then debug execution will not stop there (at the associated code line).

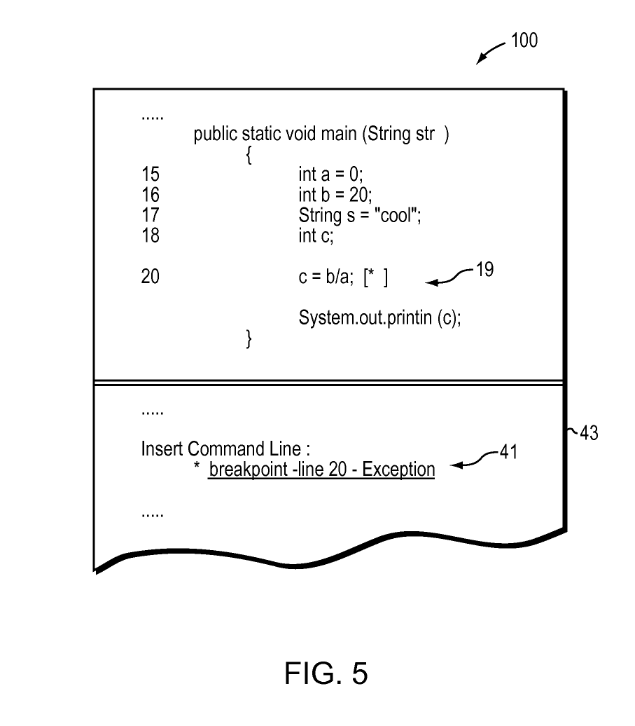

In another embodiment, exception breakpoints 19 associating an exception (and its notification) with a respective breakpoint (that is code line location specific) may be implemented as a command line option 41. FIG. 5 illustrates a command line interface 43 of a system 100 utilizing such a command line option 41. Any debugger may attach to the subject application/program code. The illustrated exception breakpoint 19 stops debugger 100 execution of the subject program code at the respective code line only when pre-evaluating the statements/expressions of that code line encounter an exception (or error-based interrupt).

This embodiment shows that the invention can also be used in command line debuggers like GDB/JDB command-line debugging. In contrast the currently available systems of the prior art are not suitable for command line usage. Such systems typically make the user confused and frustrated requiring him to maintain the region line numbers or a set of line numbers which is where the present invention gives a major advantage. No prior art debugging systems provide the above described command line option defining a breakpoint having the properties and operational qualities of the present invention exception breakpoints 19/exception notification breakpoints 19.

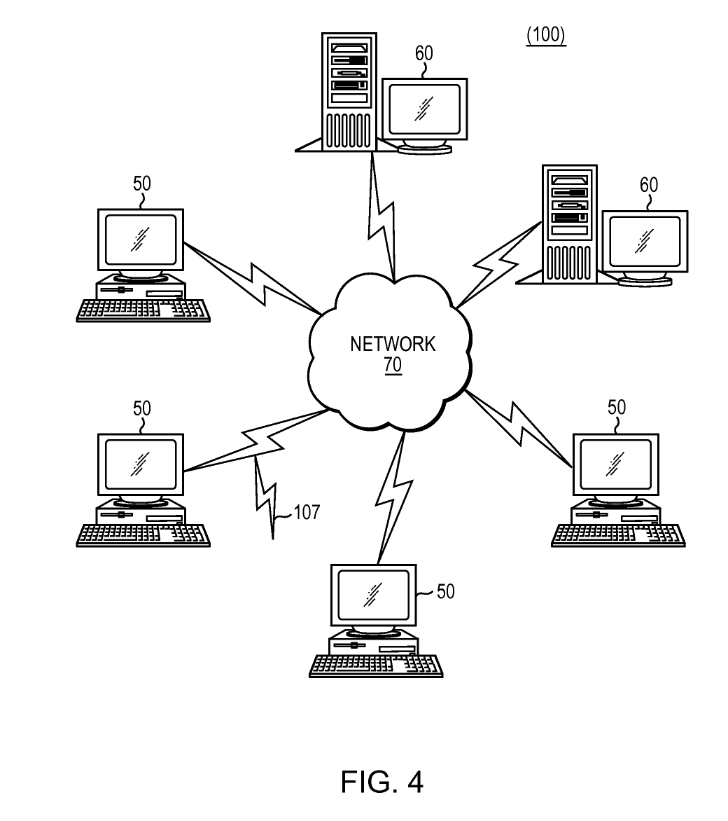

FIG. 4 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

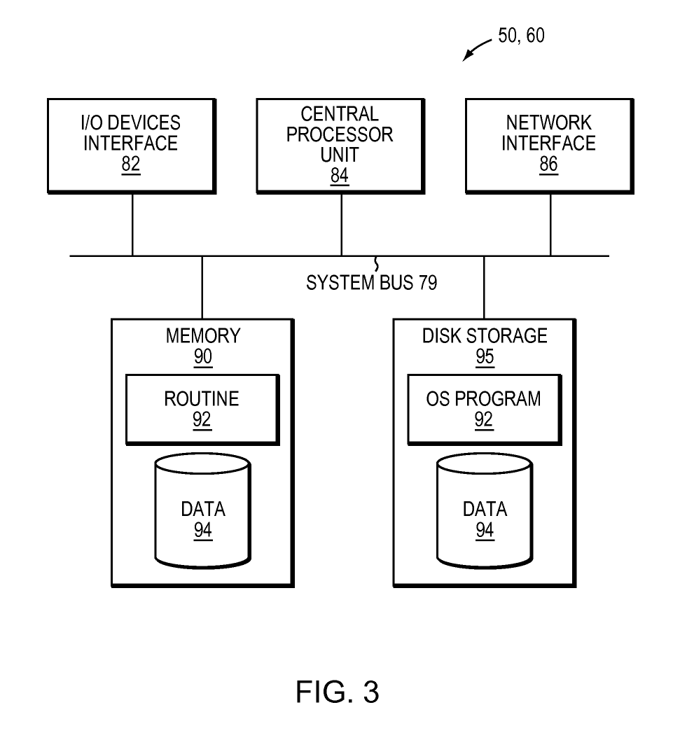

FIG. 3 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 4). Memory 90 provides volatile storage for computer software instructions 92 and data 94 used to implement an embodiment of the present invention (e.g., a source of exception breakpoints (with notification) 19, exception breakpoint properties and option 15, 41, and pre-evaluator/systems 100 employing the same as described above and further detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

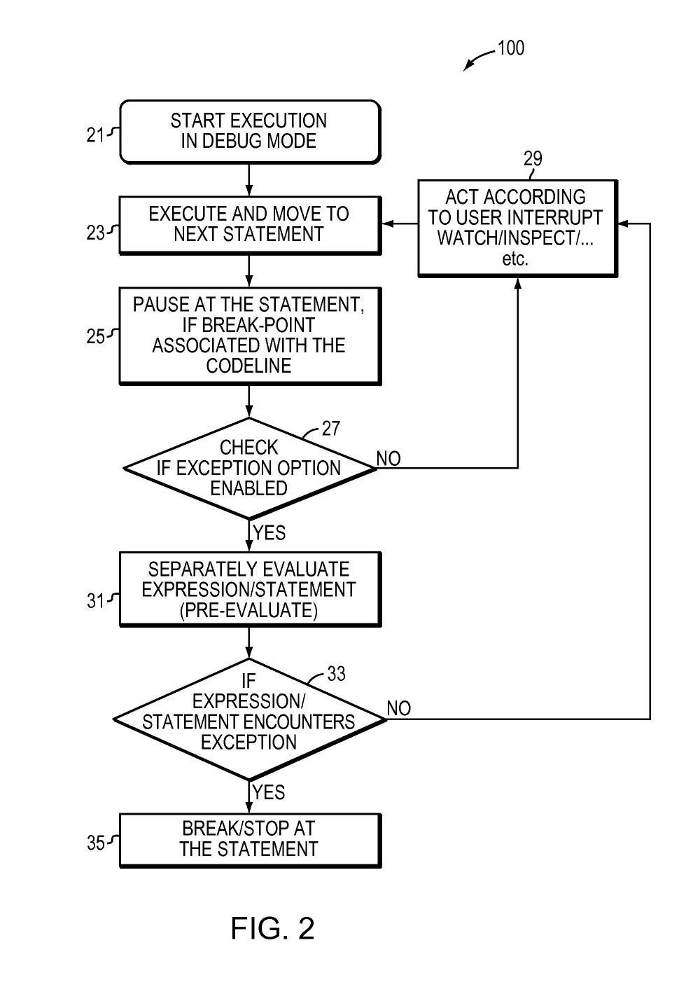

Referring now to FIG. 2, a flow diagram of one embodiment is presented. System or process 100 starts executing subject program code in debug mode at Step 21. Known techniques are used to accomplish this such as debugger or similar debugging process. From Step 23, the process 100 iterates through each line of code (or statement) as follows.

For each line of code, Step 25 determines if there is a breakpoint operatively coupled to or otherwise associated with the line. Common techniques and data structures are utilized to implement breakpoint association and breakpoint configuration and definition. In addition, the breakpoint data structure is configured to support Exception Breakpoint Option 15/command line option 41 definition and operation. If there is a breakpoint associated with the code line or statement in that code line, then system 100 (Step 27) checks if the option Exception Breakpoint (e.g., option 15 of FIG. 1 or option 41 of FIG. 5) is enabled.

If no Exception Option 15, 41 is enabled, then Step 27 passes control to Step 29. Process Step 29 acts according to user command/input for interrupt watch, inspection of subject expression/statement, etc.

If the invention Exception Breakpoint Option 15, 41 is determined at Step 27 to be enabled for the subject breakpoint, then Step 31 (a pre-evaluator or similar processor member) separately evaluates the statement/expression at that point (corresponding code line). For example, a new instance of Executor (JVM) is spawned or otherwise generated with pertinent variables, their values and the subject statement/expression/corresponding code line. In this separate evaluation, if system 100/pre-evaluator 31 determines existence of a tendency of the expression/statement to throw any type of exception or spawn an error-based interrupt (decision Step 33), then Step 35 breaks or stops execution at that statement (subject code line). In this way, process 100 (pre-evaluator/Step 31) pauses and pre-evaluates the subject code line and determines whether to apply a breakpoint 35 as a function of the subject code line statements having a potential (or would-be) exception or error interrupt. Step 33 serves an exception notification accordingly.

If decision Step 33 encounters no potential exception or potential error interrupt, then control passes to Step 29. Step 29 acts according to user command/input for interrupt watch, inspection of subject expression/statement, etc. In turn, execution in debug mode continues at Step 23.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While this invention has been particularly shown and described with references to example embodiments thereof, it will be understood by those skilled in the art that various changes in form and details may be made therein without departing from the scope of the invention encompassed by the appended claims.

What is claimed is:

1. A computer implemented method of debugging program code, comprising:
given a subject program code, associating one or more exception-breakpoints with respective different certain lines of code;
executing the subject program code in debug mode; and
during said executing, for each of the different certain lines of code: (a) determining tendency to throw an exception, and (b) at the certain line of code, stopping execution of the subject program code only if the certain line of code is determined to tend to throw or would result in an exception.

2. A method as claimed in claim 1, wherein the step of associating includes defining the one or more exception-breakpoints by enabling a respective property option in each exception breakpoint.

3. A method as claimed in claim 2, wherein the property option is user-enabled.

4. A method as claimed in claim 1, wherein said determining includes pausing and pre-evaluating the certain line of code.

5. A method as claimed in claim 1, wherein the step of determining determines tendency of the certain line of code to spawn an error-based interrupt.

6. A method as claimed in claim 5, wherein the step of stopping stops execution of the subject program only if the certain line of code is determined as tending to spawn an error-based interrupt.

7. A method as claimed in claim 1, wherein each exception-breakpoint is specific to a respective line location in the code so as to be code line location specific; and
wherein step of associating effectively assigns exception handling and exception notification to code-line location specific breakpoints.

8. A method as claimed in claim 1, wherein the step of associating may utilize a user-settable option in a command line.

9. A method as claimed in claim 1, wherein the determining and stopping simplifies error/failure analysis.

10. A method as claimed in claim 9, wherein the error/failure analysis includes analysis of failures due to any of null pointer, array out of bounds, file not found and the like.

11. A computer apparatus debugging program code, comprising:
a source of exception breakpoints with exception notification, one or more exception breakpoints being associated with respective different certain lines of a subject program code; and
a processor executing the subject program code in debug mode, during said executing, for each of the different certain lines of code, the processor: (a) determining tendency to throw an exception, and (b) at the certain line of code, stopping execution of the subject program code only if the certain line of code is determined to tend to result in an exception.

12. A computer apparatus as claimed in claim 11, wherein the source of exception breakpoints includes definitions of the one or more exception breakpoints, definition of each exception breakpoint including a property option.

13. A computer apparatus as claimed in claim 12, wherein the property option is user-enabled.

14. A computer apparatus as claimed in claim 11, wherein the processor determining tendency to throw an exception includes: pausing at the certain line of code and pre-evaluating the certain line of code.

15. A computer apparatus as claimed in claim 11, wherein the processor determines tendency of the certain line of code to spawn an error-based interrupt.

16. A computer apparatus as claimed in claim 15, wherein the processor stops execution of the subject program only if the certain line of code is determined as tending to spawn an error-based interrupt.

17. A computer apparatus as claimed in claim 11, wherein each exception breakpoint is specific to a respective line location in the code so as to be code line location specific; and
the one or more exception breakpoints effectively assign exception notification to code line location specific breakpoints.

18. A computer apparatus as claimed in claim 11, wherein one exception breakpoint is user-enabled through a command line option.

19. A computer apparatus as claimed in claim 11 wherein the processor simplifies error/failure analysis and the error/failure analysis includes analysis of failures due to any of null pointer, array out of bounds, file not found and the like.

20. A computer program product for debugging a subject application code, the computer program product comprising:
a computer readable storage medium having computer readable program code embodied therewith, the computer readable program code when executed by a computer causing:
one or more exception breakpoints with exception notification to be associated with respective different certain lines of subject application code; and
the subject application code to be executed in debug mode, wherein during said executing, for each of the different certain lines of code: (a) pausing to pre-evaluate and determine tendency to throw an exception or spawn an interrupt, and (b) at the certain line of code, stopping execution of the subject program code only if the pre-evaluating determines existence of a would-be exception or would-be interrupt.
